(19) United States
(12) Patent Application Publication
(10) Pub. No.: US 2004/0106434 A1
(43) Pub. Date: Jun. 3, 2004

(54) Mobile communication base station device and QOS control method and program thereof

(75) Inventor: Kazunori Shibasaki, Saitama (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/720,193

(22) Filed: Nov. 25, 2003

(30) Foreign Application Priority Data
Nov. 26, 2002 (JP) 2002-342678

(51) Int. Cl. H04M 1/00; H04B 1/38

(52) U.S. Cl. 455/561; 455/452.2

(57) ABSTRACT

The mobile communication base station device includes a wireless channel state monitoring unit which obtains state information of a wireless channel from a wireless unit and a coding and decoding unit to conduct monitoring, and a channel Qos management unit which gives a channel control instruction based on the state information of the wireless channel notified by the wireless channel state monitoring unit to use a band of an ATM channel appropriate for the state of the wireless channel.

### BACKGROUND OF THE INVENTION

1. Field of the Invention

The present invention relates to a mobile communication base station device for controlling an ATM channel according to a state of a wireless channel and a Qos control method and a program thereof.

2. Description of the Related Art

In conventional mobile communication base station devices, a wireless channel and an ATM channel are controlled independently of each other.

Technique related to a radio ATM transmission and reception device for transmitting, through a wireless channel, an ATM signal sent and received through an ATM interface is disclosed in Japanese Patent Laying-Open (kokai) No. Heisei 10-190740 (Literature 1). Technique of dynamically controlling a bandwidth of a relay channel according to the amount of traffic in communication between LANs is disclosed in Japanese Patent Laying-Open (kokai) No. Heisei 11-55282 (Literature 2).

The technique disclosed in Japanese Patent Laying-Open (kokai) No. Heisei 10-190740 as Literature 1 is as shown in the following.

The technique relates to a radio ATM transmission and reception device for transmitting, through a wireless channel, an ATM signal transmitted and received through an ATM interface, which device is characterized in including a transmission unit for forming a radio packet by adding predetermined header information to a plurality of ATM cells forming an ATM signal in a bundle to transmit the radio packet to a wireless channel, an analysis unit for analyzing predetermined signaling information sent and received through the ATM interface from the ATM signal to recognize a requested service class, and a reception unit for dissolving the radio packet received from the wireless channel into a unit of an original ATM cell by removing the header information from the packet to transmit the dissolved ATM cell based on the requested service class.

The technique disclosed in Japanese Patent Laying-Open (kokai) No. Heisei 11-55282 as Literature 2 is as shown in the following.

The technique relates to a method of controlling a relay channel bandwidth in a wide-area network formed of a plurality of local area networks connected through relay channels, which is characterized in measuring the amount of traffic of a protocol sent and received between each relay channel and a local area network connected to the relay channel with respect to each specific kind of communication to be monitored which is set in advance to obtain the amount of traffic of the protocol per unit time with respect to the specific kind of communication from the measurement result, and changing the bandwitdth of the relay channel by expanding the bandwidth of the relay channel when the amount of traffic in question is increased and reducing the bandwidth in question when the amount of traffic in question is reduced.

With a mobile communication base station device, however, because a wireless channel and an ATM channel are controlled independently, a band of the ATM channel is ensured in advance assuming the amount of data to be served, so that the band of the ATM channel is maintained even when a state of the wireless channel changes to be bad or good in time series. In other words, even when the wireless channel enters a bad state to reduce the band, the band of the ATM channel remains unchanged, resulting in failing in effective use of the ATM channel.

In addition, since the technique recited in the above-described Literature 2 relates to a relay device linking LANs with each other, unlike a case of a wireless channel for communication with a mobile apparatus, no channel state will change in time series according to the technique.

### SUMMARY OF THE INVENTION

An object of the present invention, which is invented in view of the above-described circumstances, is to provide a mobile communication base station device, and a Qos control method and a program thereof enabling Qos control of an ATM network which reflects a state of a wireless channel environment between the mobile communication base station and a mobile apparatus taking the fact that a band of the wireless channel is changed according to the state into consideration.

According to the first aspect of the invention, a mobile communication base station device which conducts radio communication with a plurality of mobile apparatuses connected to an ATM network, comprises a wireless unit which conducts modulation and demodulation for communicating with a mobile apparatus through a wireless channel, a coding and decoding unit which conducts coding into a wireless channel format for the communication through the wireless channel or conversely conducts decoding, a channel control unit which conducts control such that a band of an ATM channel has a band instructed by a channel Qos management unit, a wireless channel state monitoring unit which obtains state information of the wireless channel from the wireless unit and the coding and decoding unit to conduct monitoring, and the channel Qos management unit which gives a channel control instruction based on the state information of the wireless channel notified by the wireless channel state monitoring unit to use a band of the ATM channel appropriate for the state of the wireless channel.

According to another aspect of the invention, a Qos control method in a mobile communication base station device having a wireless unit which conducts modulation and demodulation for communicating with a mobile apparatus through a wireless channel, a coding and decoding unit which conducts coding into a wireless channel format for the communication through the wireless channel or conversely conducts decoding, and a channel control unit which controls an ATM channel band to execute radio communication with a plurality of mobile apparatuses connected to an ATM network, comprising the steps of obtaining state information of the wireless channel, and giving a channel control instruction based on the obtained state information of the wireless channel to use a band of the ATM channel appropriate for the state of the wireless channel.

According to another aspect of the invention, a Qos control method in a mobile communication base station device having a wireless unit which conducts modulation and demodulation for communicating with a mobile apparatus through a wireless channel, a coding and decoding unit which conducts coding into a wireless channel format for the communication through the wireless channel or conversely conducts decoding, and a channel control unit which controls an ATM channel band to execute radio communication with a plurality of mobile apparatuses connected to an ATM network, comprises a wireless channel state monitoring step of obtaining state information of the wireless channel from the wireless unit and the coding and decoding unit to conduct monitoring, and a channel Qos management step of giving a channel control instruction based on the state information of the wireless channel notified by the wireless channel state monitoring step to use a band of the ATM channel appropriate for the state of the wireless channel.

According to another aspect of the invention, the Qos control program as set forth in claim 10, wherein the channel Qos management function instructs the channel control unit to set priority to each data received from the plurality of mobile apparatuses according to a state of each wireless channel through which the data in question is transmitted and received and conduct relay through the ATM channel based on the priority in question, and which further executes a delay time management function of controlling the coding and decoding unit to, at the time of decoding data received from the wireless unit, store time when the decoding is started and at the time of relaying data to the channel control unit, transfer the data together with the time information, and a data abandonment control function of controlling the channel control unit to abandon data whose delay exceeds a designated delay time.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure of an embodiment according to the present invention;

FIG. 2 is a diagram showing a relationship between a wireless channel state and a wireless channel band;

FIG. 3 is a diagram showing a wireless channel state and ATM channel band control following the change of the state in time series;

FIG. 4 is a diagram showing the priority in data relay to the ATM channel according to circumstances of a wireless channel state; and

FIG. 5 is a diagram showing a relationship between a state of the wireless channel and data to be abandoned.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

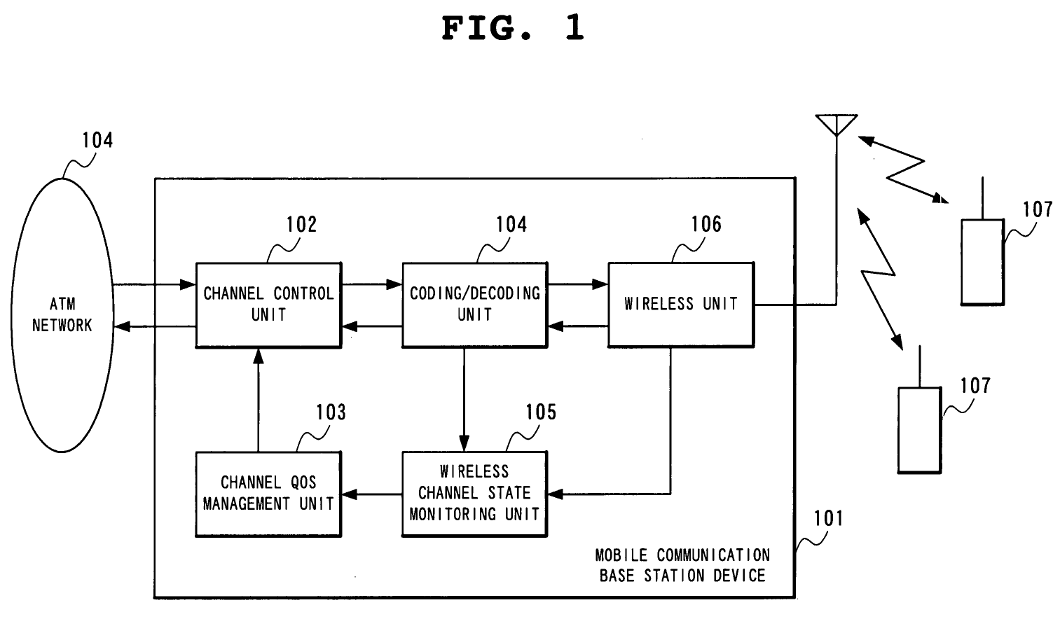

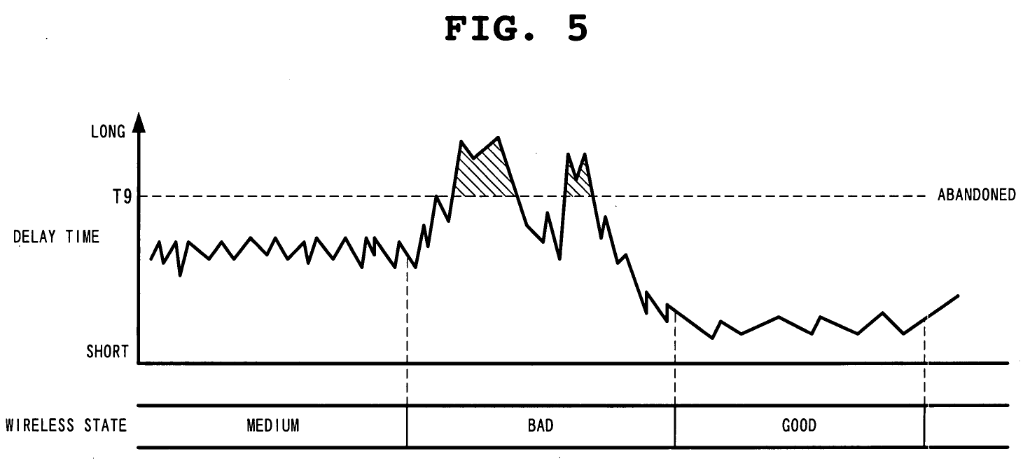

Next, detailed description will be made of an embodiment of a mobile communication base station device, and a Qos control method and a program thereof according to the present invention with reference to the accompanying drawings. FIGS. 1 to 5 show the embodiment of the mobile communication base station device, and the Qos control method and the program thereof according to the present invention.

First, with reference to FIG. 1, the structure of the mobile communication base station device 101 will be described. As illustrated in FIG. 1, the mobile communication base station device 101 includes a channel control unit 102, a channel Qos (Quality of Service) management unit 103, a coding/decoding unit 104, a wireless channel state monitoring unit 105 and a wireless unit 106.

The wireless unit 106 is a functional unit for executing modulation/demodulation to communicate with a mobile apparatus 107 through a wireless channel.

The coding/decoding unit 104 is a functional unit for executing coding into a wireless channel format for the communication using a wireless channel and conversely executing decoding.

The channel control unit 102 is a functional unit for receiving a control instruction from the channel Qos management unit 103 to execute specific Qos control with respect to an ATM network.

The channel Qos management unit 103 is a functional unit for receiving wireless channel monitoring information from the wireless channel state monitoring unit 105 to instruct on/manage a Qos control method for the ATM network appropriate for the state of the wireless channel.

The wireless channel state monitoring unit 105 is a functional unit for obtaining information about a state of the wireless channel from the coding/decoding unit 104 and the wireless unit 106.

After passing through the channel control unit 102, data received from the ATM network is coded into a format for a wireless channel at the coding/decoding unit 104, modulated at the wireless unit 106 and sent to the mobile apparatus 107 through an antenna. On the other hand, data from the mobile apparatus 107 is received at the wireless unit 106 through the antenna and demodulated, decoded into the ATM channel format at the coding/decoding unit 104 and transmitted to the ATM network through the channel control unit 102.

In addition, the wireless channel state monitoring unit 105 obtains state information of the wireless channel from the wireless unit 106 and the coding/decoding unit 104 to execute state monitoring and informs the channel Qos management unit 103 of the monitoring result.

The channel Qos management unit 103 gives to the channel control unit 102 a channel Qos control instruction based on the report of the wireless channel state from the wireless channel state monitoring unit 105 such that ATM network channel control appropriate for the wireless channel state can be conducted.

Thus structured present embodiment aims at, noticing that a band of a wireless channel is changed according to a state of wireless channel environments between the mobile communication base station and the mobile apparatus, conducting Qos control of the ATM network while reflecting the state, thereby totaling realizing efficient use of the channels in data relay between the wireless channel and the ATM network.

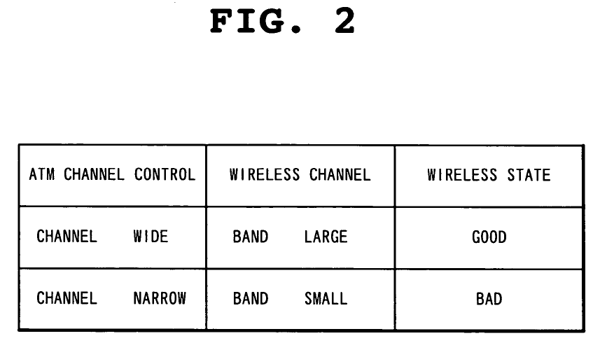

In general, when in a good wireless state, the amount of communication is large to enable high-speed communication (to enable a wireless channel band to be increased) because of lack of interference from other radio waves and the like. FIG. 2 shows a relationship between a wireless channel state and a wireless channel band.

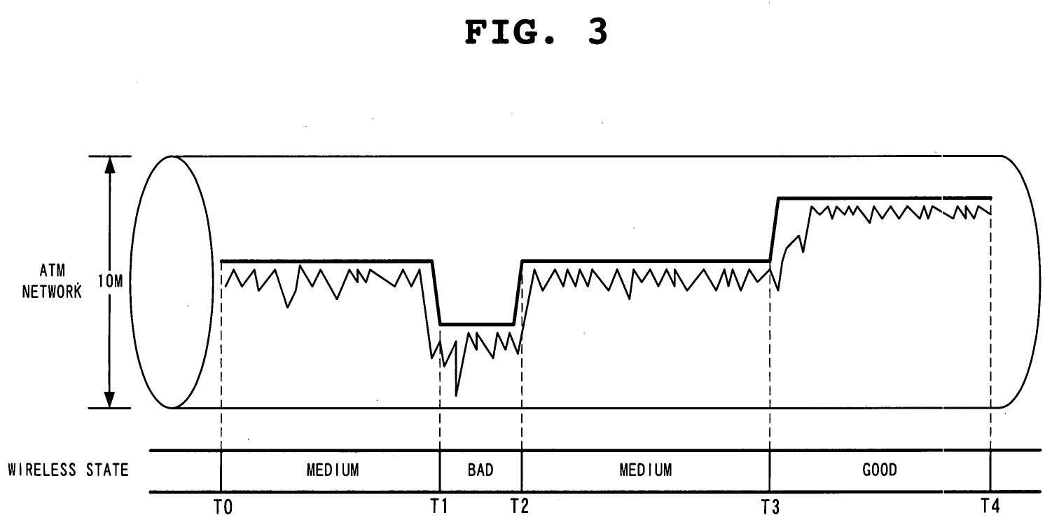

Procedure of operation of conducting band control of the ATM channel according to circumstances of a wireless channel state will be described with reference to FIG. 3. FIG. 3 shows a wireless channel state and band control of the ATM channel following the change of the state in time series. It is assumed that data relayed from the wireless channel to the ATM network is generated at a burst and its means transmission rate is defined as a band.

At time T0 to T1, the wireless channel monitoring unit 105 finds that the state of the wireless channel is medium from the information of the coding/decoding unit 104 and the wireless unit 106. In the present embodiment, the data rate of the wireless channel at this time is assumed to be 5 Mbps.

The channel Qos management unit 103 gives to the channel control unit 102 an instruction such that the band of the ATM channel is 5 Mbps as well. The channel control unit 102 having received the instruction conducts control such that the band of the ATM channel is 5 Mbps.

At time T1 to T2 shown in FIG. 3, the wireless channel monitoring unit 105 finds that the state of the wireless channel is bad from the information of the coding/decoding unit 104 and the wireless unit 106. In the present embodiment, the data rate of the wireless channel at this time is assumed to be 1 Mbps. The channel Qos management unit 103 gives to the channel control unit 102 an instruction such that the band of the ATM channel is 1 Mbps as well. The channel control unit 102 having received the instruction conducts control such that the band of the ATM channel is 1 Mbps.

At time T3 to T4 shown in FIG. 3, the wireless channel monitoring unit 105 finds that the state of the wireless channel is good from the information of the coding/decoding unit 104 and the wireless unit 106. In the present embodiment, the data rate of the wireless channel at this time is assumed to be 8 Mbps. The channel Qos management unit 103 gives to the channel control unit 102 an instruction such that the band of the ATM channel is 8 Mbps as well. The channel control unit 102 having received the instruction controls the band of the ATM channel to be 8 Mbps.

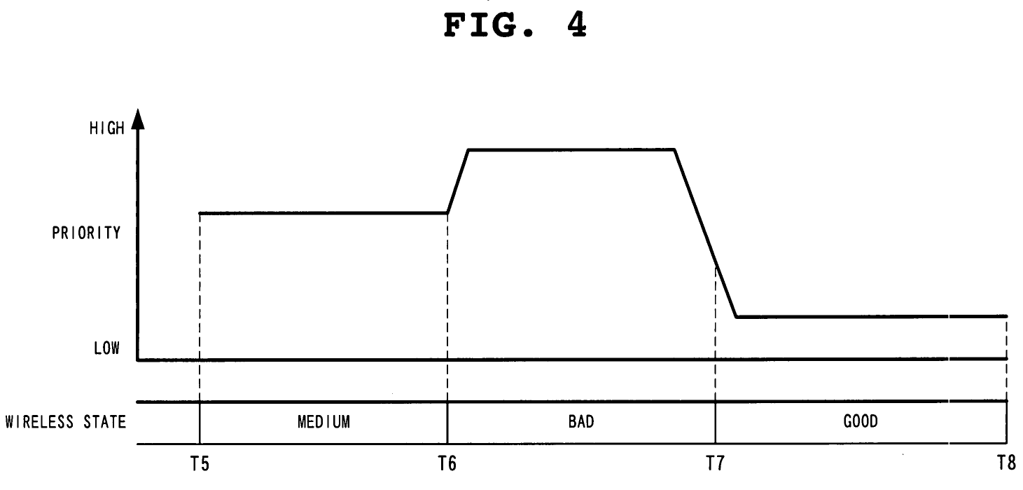

Next, description will be made of an example of control related to the priority in relaying data to the ATM channel according to the circumstances of the wireless channel state with reference to FIG. 4.

At time T5 to T6, the wireless channel monitoring unit 105 finds that the state of the wireless channel is medium from the information of the coding/decoding unit 104 and the wireless unit 106. The channel Qos management unit 103 gives to the channel control unit 102 an instruction so as to set the priority of data relay to the ATM channel to be medium. When relaying data relayed from the coding/decoding unit 104 to the ATM channel, the channel control unit 102 having received the instruction relays the data with the medium priority in comparison with the data from other mobile apparatus 107.

At time T6 to T7, the wireless channel monitoring unit 105 finds that the state of the wireless channel is bad from the information of the coding/decoding unit 104 and the wireless unit 106. The channel Qos management unit 103 gives to the channel control unit 102 an instruction to set the priority of data relay to the ATM channel to be high because the bad wireless channel state reduces the band to have a low relay frequency of data relayed at a burst. When relaying data relayed from the coding/decoding unit 104 to the ATM channel, the channel control unit 102 having received the instruction relays the data with the priority higher than that of the data from other mobile apparatus 107.

At time T7 to T8, the wireless channel monitoring unit 105 finds that the state of the wireless channel is good from the information of the coding/decoding unit 104 and the wireless unit 106. The channel Qos management unit 103 gives to the channel control unit 102 an instruction to set the priority of data relay to the ATM channel to be low because the good wireless channel state increases the band to have a high relay frequency of data relayed at a burst. When relaying data relayed from the coding/decoding unit 104 to the ATM channel, the channel control unit 102 having received the instruction relays the data with the priority lower than that of the data from other mobile apparatus 107.

As described in the foregoing, since according to the state of the wireless channel, the ATM channel control appropriate for the wireless state can be conducted, effective use of the ATM channel band is enabled.

In addition, because a band similar to a band used in the wireless channel is used for the ATM channel, only a minimum necessary band can be used on the ATM channel and when charging a channel using fee on an ATM channel bandwidth basis, minimum necessary charging is possible.

Moreover, since the priority in relay to the ATM channel is controlled according to a state of the wireless channel, even when the wireless state is bad, data is preferentially relayed to the ATM channel to enable a delay in a total relay time within the mobile communication base station to be reduced as much as possible.

Next, a second embodiment of the present invention will be described with reference to the accompanying drawings.

In the present embodiment, when data received from the wireless channel unit 106 is decoded at the coding/decoding unit 104, time when the decoding is started is stored and its time information is relayed when relaying the data to the channel control unit 102. In general, when the wireless channel is in a bad state, decoding takes time because of such control as re-transmission on the wireless channel. The channel Qos management unit 103 starts decoding and gives to the channel control unit 102 an instruction to abandon data whose delay exceeds a delay time T9.

The channel control unit 102 conducts control so as to abandon data whose delay time exceeds the delay time T9 due to a bad wireless channel state. While in a conventional mobile communication base station device, when data whose delay time is long is relayed to an ATM channel, the data will be abandoned on a higher-order device side, in the present embodiment, the data is already abandoned at the mobile communication base station, so that load on the ATM channel can be reduced.

The above-described embodiments are preferred embodiments of the present invention. The present invention, however, is not limited thereto and can be implemented in various forms within the spirit and scope of the present invention.

As is clear from the foregoing description, the present invention enables effective use of an ATM channel band because according to a state of a wireless channel, the ATM channel control appropriate for a wireless state can be conducted.

In addition, because a band similar to a band used in the wireless channel is used for the ATM channel, only a minimum necessary band can be used on the ATM channel and when charging a channel using fee on an ATM channel bandwidth basis, minimum necessary charging is possible.

Moreover, since the priority in relay to the ATM channel is controlled according to a state of the wireless channel, even when the wireless state is bad, data is preferentially relayed to the ATM channel to enable a delay in a total relay time within the mobile communication base station to be reduced as much as possible.

While in a conventional mobile communication base station device, when data whose delay time is long is relayed to an ATM channel, the data will be abandoned on a higher-order device side, in the present embodiment, the data is already abandoned at the mobile communication base station, so that load on the ATM channel can be reduced.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A mobile communication base station device which conducts radio communication with a plurality of mobile apparatuses connected to an ATM network, comprising:
a wireless unit which conducts modulation and demodulation for communicating with a mobile apparatus through a wireless channel,
a coding and decoding unit which conducts coding into a wireless channel format for the communication through the wireless channel or conversely conducts decoding,
a channel control unit which conducts control such that a band of an ATM channel has a band instructed by a channel Qos management unit,
a wireless channel state monitoring unit which obtains state information of the wireless channel from said wireless unit and said coding and decoding unit to conduct monitoring, and
said channel Qos management unit which gives a channel control instruction based on the state information of the wireless channel notified by said wireless channel state monitoring unit to use a band of the ATM channel appropriate for the state of the wireless channel.

2. The mobile communication base station device as set forth in claim 1, wherein
said channel Qos management unit
instructs said channel control unit to set priority to each data received from the plurality of mobile apparatuses according to a state of each wireless channel through which the data in question is transmitted and received and conduct relay through said ATM channel based on the priority in question.

3. The mobile communication base station device as set forth in claim 1, wherein
said coding and decoding unit, at the time of decoding data received from said wireless unit, stores time when the decoding is started and at the time of relaying data to said channel control unit, transfers the data together with said time information, and
said channel control unit conducts control to abandon data whose delay exceeds a delay time designated by an instruction from said channel Qos management unit.

4. The mobile communication base station device as set forth in claim 1, wherein
said channel Qos management unit
instructs said channel control unit to set priority to each data received from the plurality of mobile apparatuses according to a state of each wireless channel through which the data in question is transmitted and received and conduct relay through said ATM channel based on the priority in question,
said coding and decoding unit, at the time of decoding data received from said wireless unit, stores time when the decoding is started and at the time of relaying data to said channel control unit, transfers the data together with said time information, and
said channel control unit conducts control to abandon data whose delay exceeds a delay time designated by an instruction from said channel Qos management unit.

5. A Qos control method in a mobile communication base station device having a wireless unit which conducts modulation and demodulation for communicating with a mobile apparatus through a wireless channel, a coding and decoding unit which conducts coding into a wireless channel format for the communication through the wireless channel or conversely conducts decoding, and a channel control unit which controls an ATM channel band to execute radio communication with a plurality of mobile apparatuses connected to an ATM network, comprising the steps of:
obtaining state information of the wireless channel, and
giving a channel control instruction based on the obtained state information of the wireless channel to use a band of the ATM channel appropriate for the state of the wireless channel.

6. A Qos control method in a mobile communication base station device having a wireless unit which conducts modulation and demodulation for communicating with a mobile apparatus through a wireless channel, a coding and decoding unit which conducts coding into a wireless channel format for the communication through the wireless channel or conversely conducts decoding, and a channel control unit which controls an ATM channel band to execute radio communication with a plurality of mobile apparatuses connected to an ATM network, comprising:
a wireless channel state monitoring step of obtaining state information of the wireless channel from said wireless unit and said coding and decoding unit to conduct monitoring, and
a channel Qos management step of giving a channel control instruction based on the state information of the wireless channel notified by said wireless channel state monitoring step to use a band of the ATM channel appropriate for the state of the wireless channel.

7. The Qos control method as set forth in claim 6, wherein
said channel Qos management step
instructs said channel control unit to set priority to each data received from the plurality of mobile apparatuses according to a state of each wireless channel through which the data in question is transmitted and received and conduct relay through said ATM channel based on the priority in question.

8. The Qos control method as set forth in claim 6, further comprising:
a delay time management step of controlling said coding and decoding unit to, at the time of decoding data received from said wireless unit, store time when the decoding is started and at the time of relaying data to said channel control unit, transfer the data together with said time information, and
a data abandonment control step of controlling said channel control unit to abandon data whose delay exceeds a designated delay time.

9. The Qos control method as set forth in claim 6, wherein
said channel Qos management step
instructs said channel control unit to set priority to each data received from the plurality of mobile apparatuses according to a state of each wireless channel through which the data in question is transmitted and received and conduct relay through said ATM channel based on the priority in question, and which further comprises:
a delay time management step of controlling said coding and decoding unit to, at the time of decoding data received from said wireless unit, store time when the decoding is started and at the time of relaying data to said channel control unit, transfer the data together with said time information, and
a data abandonment control step of controlling said channel control unit to abandon data whose delay exceeds a designated delay time.

10. A Qos control program in a mobile communication base station device having a wireless unit which conducts modulation and demodulation for communicating with a mobile apparatus through a wireless channel, a coding and decoding unit which conducts coding into a wireless channel format for the communication through the wireless channel or conversely conducts decoding, and a channel control unit which controls an ATM channel band to execute radio communication with a plurality of mobile apparatuses connected to an ATM network, comprising:
a wireless channel state monitoring function of obtaining state information of the wireless channel from said wireless unit and said coding and decoding unit to conduct monitoring, and
a channel Qos management function of giving a channel control instruction based on the state information of the wireless channel notified by said wireless channel state monitoring function to use a band of the ATM channel appropriate for the state of the wireless channel.

11. The Qos control program as set forth in claim 10, wherein
said channel Qos management function
instructs said channel control unit to set priority to each data received from the plurality of mobile apparatuses according to a state of each wireless channel through which the data in question is transmitted and received and conduct relay through said ATM channel based on the priority in question.

12. The Qos control program as set forth in claim 10, which executes:
a delay time management function of controlling said coding and decoding unit to, at the time of decoding data received from said wireless unit, store time when the decoding is started and at the time of relaying data to said channel control unit, transfer the data together with said time information, and
a data abandonment control function of controlling said channel control unit to abandon data whose delay exceeds a designated delay time.

13. The Qos control program as set forth in claim 10,
said channel Qos management function
instructs said channel control unit to set priority to each data received from the plurality of mobile apparatuses according to a state of each wireless channel through which the data in question is transmitted and received and conduct relay through said ATM channel based on the priority in question, and which further executes:
a delay time management function of controlling said coding and decoding unit to, at the time of decoding data received from said wireless unit, store time when the decoding is started and at the time of relaying data to said channel control unit, transfer the data together with said time information, and
a data abandonment control function of controlling said channel control unit to abandon data whose delay exceeds a designated delay time.
